(19) United States
(12) Patent Application Publication
(10) Pub. No.: US 2026/0170984 A1
(43) Pub. Date: Jun. 18, 2026

(54) Display Control for Always-On Display Modes for Computing Devices

(71) Applicant: Google LLC, Mountain View, CA (US)

(72) Inventors: Ion Bita, Los Altos, CA (US); Yen-Cheng Chen, Taipei (TW); Nai-Hsuan Liu, Cupertino, CA (US); Shreerag Jayakrishnan, San Francisco, CA (US); Patrik Torstensson, Morgan Hill, CA (US); Vincent Hoaman Tam, San Francisco, CA (US); Taesung Kim, Cupertino, CA (US); Jonathan David Hurwitz, San Jose, CA (US)

(21) Appl. No.: 19/111,132

(22) PCT Filed: Jul. 27, 2022
(86) PCT No.: PCT/US2022/038536

§ 371 Date: Mar. 12, 2025

(51) Int. Cl. G09G 3/20; G09G 3/3233; G09G 3/36

(52) U.S. Cl. CPC G09G 3/2003; G09G 3/3233; G09G 3/36; G09G 3/3611; G09G 2300/0452; G09G 2300/0842

(57) ABSTRACT

A method for refreshing pixels of a display operating in an always-on mode includes: identifying a plurality of pixels of the display that are activated while the display is operating in the always-on mode, dividing the plurality of pixels into at least a first subset of the pixels (110) and a second subset of the pixels (120), the first subset of the pixels and the second subset of the pixels being mutually exclusive, and alternately activating and deactivating the first subset of pixels and the second subset of pixels.

### FIELD

The present disclosure relates to controlling the display of a computing device. In particular, the present disclosure is generally related to controlling a display screen of a computing device, especially for wearable computing devices such as smart watches or other smart wearable devices. In particular, aspects of the disclosed invention take advantage of high-resolution organic light-emitting diode (“OLED”) displays to periodically turn off different sets of pixels on the display, which helps prevent visual artifacts developing on the display while still providing a full image for display such that a user can still continuously view the display screen at a glance.

### BACKGROUND

It is desirable on mobile computing devices, and especially on smart wearable devices, to present content for display in a quickly accessible and glanceable way. The goal is to allow users to access information by viewing the content and/or perform actions, such as button presses, quickly without explicitly invoking a main system display. A common method for achieving this is having the mobile computing device be in an “always-on display” mode (“AOD”). In an AOD mode, content is displayed on the screen even if the user is not explicitly interacting with the device.

Mobile computing devices spend most of their time in an idle state. This is especially true for wearable computing devices, as user interactions with wearable computing devices are often short and abbreviated. Therefore, wearable computing devices will spend a majority of time in the AOD mode, displaying the same content for extended periods of time.

OLED displays are prone to image retention when stationary image content is displayed for long periods of time, which manifests as visible artifacts of a static image “underlaid” newly displayed content shown when the screen is refreshed. These visible artifacts look like a “ghost” or reproduction of a previously displayed image. The presence of these visible artifacts may be transitory in nature, but can signal quality issues or defects in the display. In some cases, the visible artifacts can be permanent and become “burned in,” permanently causing the visible artifact to be visible.

Existing mitigation solutions for visible artifacts include the use of more expensive and advanced OLED panels or user interface solutions where content is shifted across the screen to minimize the fraction of time a stationary image is displayed.

### SUMMARY

Aspects and advantages of embodiments of the present disclosure will be set forth in part in the following description, or can be learned from the description, or can be learned through practice of the embodiments.

In one embodiment, a method for refreshing pixels of a display operating in an always-on mode can be provided. The method can include identifying a plurality of pixels of the display that are activated while the display is operating in the always-on mode and dividing the plurality of pixels into at least a first subset of the pixels and a second subset of the pixels, the first subset of the pixels and the second subset of the pixels being mutually exclusive. The method can also include alternately activating and deactivating the first subset of pixels and the second subset of pixels.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates representations of displayed content when different groups of pixels are turned off according to some implementations of the present disclosure.

FIG. 2 illustrates a display of a wearable computing device according to some implementations of the present disclosure.

FIG. 3 illustrates a process for selecting pixels to be turned off on a display of a wearable computing device according to some implementations of the present disclosure.

FIG. 4 illustrates a chart showing a comparison of image retention contrast according to some implementations of the present disclosure.

FIG. 5 illustrates a method for displaying content on a display of a computing device according to some implementations of the present disclosure.

FIG. 6 illustrates a method for alternately activating and deactivating subsets of pixels on a display of a computing device according to some implementations of the present disclosure.

FIG. 7 illustrates a wearable computing device according to some implementations of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

The present disclosure is generally related to controlling a display screen of a computing device, especially for wearable computing devices such as smart watches or other smart wearable devices. In particular, aspects of the disclosed invention take advantage of OLED displays to periodically turn off different sets of pixels on the display, which helps prevent visual artifacts developing on the display while still providing a full image for display such that a user can still continuously view the display screen at a glance.

The proposed invention solves deficiencies of prior systems by taking advantage of the use of high-resolution OLED displays to periodically turn off different sets of pixels while content is being displayed in an AOD mode. This allows pixel-level “relaxation” of image retention elements while still continuously displaying an image with stationary elements in the AOD mode. Pixels that are displaying content can be subdivided into pixel groups. Each pixel group can be a full representation of the displayed content, except at a lower overall resolution (e.g., 160 ppi instead of 320 ppi) than if each pixel was left permanently on to display content. Each pixel group can, in turn, be turned off while other pixel groups are left on or are turned back on, which allows pixels in each group to be relaxed in turn. After cycling through each set of pixels, the entire screen area of the display has been “refreshed” and can continue to be cycled in this manner to allow localized, pixel-level relaxation while still displaying desired image content for extended periods of time while the computing device is in the AOD mode.

This method of controlling pixel relaxation for groups of pixels is advantageous because it can be implemented in software without changes to the underlying display hardware. For example, an alpha display layer can be used, which is a display layer that sits on top of all other display layers. This alpha display layer can include information about which pixels should be turned off for each cycle of pixel relaxation. When the user interface image of displayed content is composited (e.g., when various display layers are output for display), the alpha display layer indicates which pixels should be turned off regardless of what should be displayed in layers underneath the alpha display layer. Thus, the displayed content is displayed without noticeable impact from having different pixel groups turned off. Furthermore, each time the displayed content must update (e.g., when a displayed time changes), the alpha display layer can switch to a different set of pixels that should be turned off. Thus, pixels can be saved from overuse and “ghost” images can be better prevented without the need for a change in hardware of the computing device.

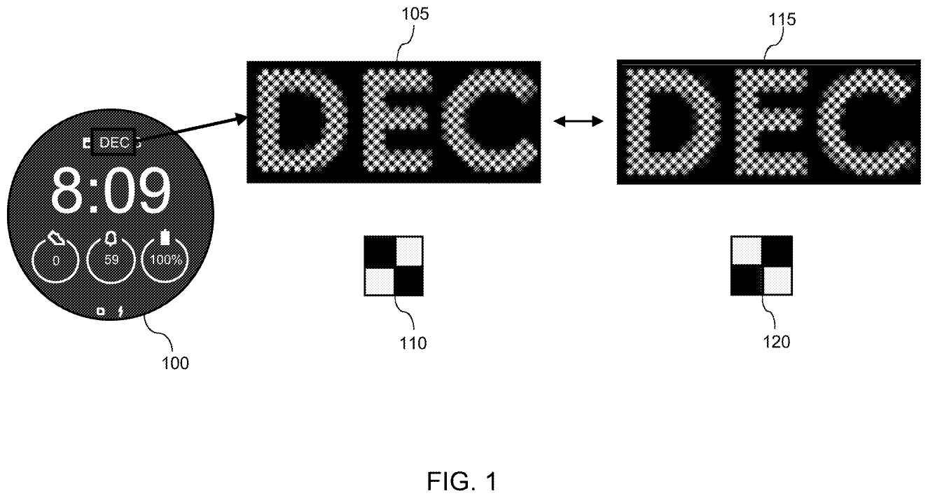

Referring now to the FIGS., FIG. 1 illustrates representations of displayed content 100 when different groups of pixels are turned off according to some implementations of the present disclosure.

First representation 105 illustrates a magnified portion of displayed content 100 with a first set of pixels 110 turned off. In first representation 105, pixels making up the displayed content 100 are divided into four-pixel square units. First set of pixels 110 can include, for example, an upper-left pixel of the four-pixel square unit and a lower-right pixel of the four-pixel square unit. When these pixels are turned off, the displayed content 100 can be displayed at a lower resolution than if all four pixels in the four-pixel square unit were turned on.

Second illustration 115 illustrates a magnified portion of displayed content 100 with a second set of pixels 120 turned off. Second set of pixels 120 can include, for example, an upper-right pixel of the four-pixel square unit and a lower-left pixel of the four-pixel square unit. When these pixels are turned off, the displayed content can be displayed at a lower resolution than if all four pixels in the four-pixel square unit were turned on.

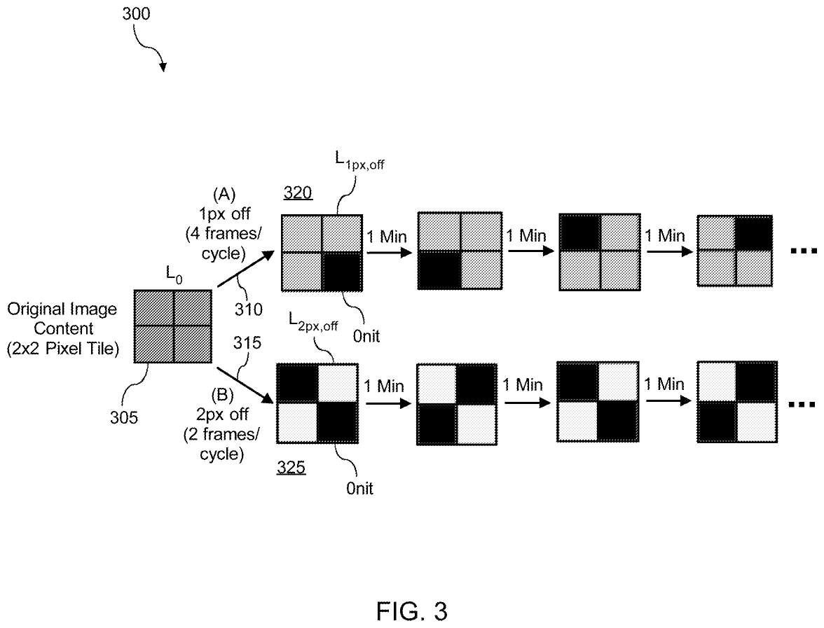

In some embodiments, first set of pixels 110 and second set of pixels 120 include only one pixel that is turned off, such as only one pixel of the four-pixel square unit. Additional details regarding the selection of two or one pixel to be turned off in each of the first set of pixels 110 and the second set of pixels 120 can be found below in relation to FIG. 3.

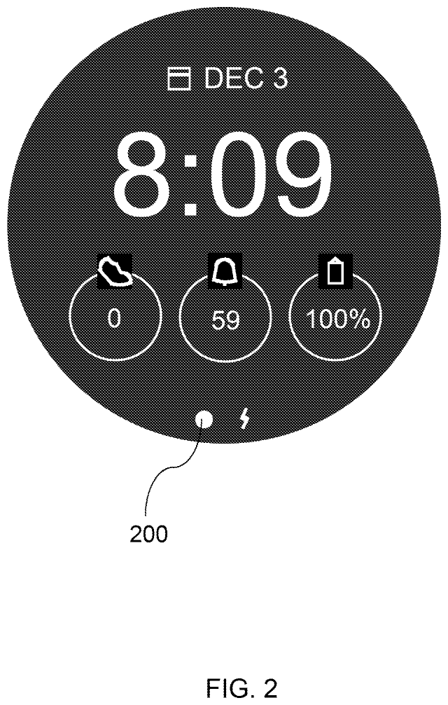

FIG. 2 illustrates a display 200 of a wearable computing device according to some implementations of the present disclosure. While it is contemplated that aspects of the present disclosure can be used for any computing device that includes a display, especially an OLED display, aspects of the present disclosure are particularly advantageous for mobile and wearable computing devices, as content displayed on these types of computing device are usually presentable in quickly accessible way (e.g., “at a glance”). This allows users to access information by viewing the content, and sometimes even perform actions, quickly without needing to invoke the computing system, such as by performing “wake-up” functions to activate the computing system. This is commonly accomplished by operating the computing device in an AOD mode, where content is displayed on the display even when the user is not explicitly interacting with the computing device, especially wearable computing devices where device interactions are often short and abbreviated. Therefore, these devices will spend a majority of the time in this AOD mode, displaying the same content for long periods of time.

The display 200 can include various information that a user of the wearable computing device may wish to access. For example, the display 200 can include a current date, a current time, a number of steps the user of the wearable computing device has taken, battery information for the wearable computing device, notification information for various software applications, settings information, weather information for a current location of the wearable computing device, display options, and the like.

FIG. 3 illustrates a process 300 for selecting pixels to be turned off on a display of a wearable computing device according to some implementations of the present disclosure.

As described above with regards to FIG. 1, areas of the display 100 can be subdivided into four-pixel square units, such as pixel unit 305. Two different approaches can be used to control the display 100. In a first approach 310, four separate pixel groups (e.g., four groups of one pixel each corresponding to one of the pixels of the pixel unit 305) can be used. In a second approach 315, two separate pixel groups (e.g., two groups of two pixels each, where the pixels in the same group are located diagonally from one another, such as an upper-left pixel and a lower-right pixel) can be used.

In the first approach 310, each of the four-pixel groups (e.g., each individual pixel of the pixel unit 305) can be turned off in turn. For example, as shown in operation 320, a bottom-right pixel of the pixel unit 305 can be turned off first. After a period of time, such as one minute, the bottom-right pixel of the pixel unit 305 can be turned back on and a bottom-left pixel of the pixel unit 305 can then be turned off. This can be repeated in turn for the top-left pixel and the top-right pixel, after which the operation 320 can be repeated indefinitely, with the entire display being refreshed after 4 cycles. The first approach 310 is advantageous because it allows the display to maintain a desired display resolution (e.g., 320 PPI) while still allowing for pixel relaxation for each of the individual pixels in turn in the pixel unit 305.

In the second approach 315, each of the two-pixel groups can be turned off in turn. For example, as shown in operation 325, a pixel group including the bottom-right pixel and the upper-left pixel can be turned off. After a period of time, such as one minute, the pixels in this first pixel group can be turned back on and the other two pixels in the pixel unit 305 (e.g., the second pixel group including the upper-right pixel and the bottom-left pixel of the pixel unit 305) can be turned off. Operation 325 can then be repeated indefinitely. The second approach 315 is advantageous because, while display resolution is halved (e.g., from 320 PPI to 160 PPI), less refresh cycles are required to refresh the entire display, which can save battery life of the wearable computing device.

In either approach, pixels are mutually exclusive to one pixel group. For example, a pixel can only be assigned to one of the four groups in the first approach 310 or one of the two groups in the second approach 320.

When pixels are turned off, a resulting perceived brightness of the display can be affected. For example, a display calibrated at 3 nits would appear with a perceived brightness of 1.5 nits if the second approach 315 (turning off two pixels at once) is used. In some embodiments, it is desirable to have a reduction in brightness, such as when the computing device is operating at night or in other low-light conditions, or when the computing device is docked for charging.

In regular ambient light conditions, however, it may be desired to maintain a target display brightness set by the brightness of the environment. In order to compensate for the reduced perceived brightness, a display brightness value of pixels that are currently not turned off can be boosted. For example, given a desired brightness of 75 nits, using first approach 310, the display brightness value of the on pixels can be boosted to 100 nits while the fourth pixel is turned off. Using second approach 315, each of the two pixels that are on can be boosted to 150 nits while the other two pixels are off.

In some embodiments, this change in display brightness can be affected dynamically based on an outside brightness detected by, for example, an ambient light sensor input.

However, using this measurement alone can result in dimming the display below a desired value in a given environment. Therefore, a custom look-up table can be used for AOD mode. For example, in the case of the second approach 315 being used (where two pixels are turned off per cycle), the custom look-up table would need to specify a desired brightness value twice as large relative to a normal display mode (e.g., if a normal operating mode would require 50 nits of brightness, a computing device operating in AOD would require 100 nit brightness).

In some embodiments, both the first approach 310 and the second approach 315 can include using an alpha layer. The alpha layer is a display layer for the display of the computing device implemented in software that can control which pixels are finally displayed, regardless of signals controlling the underlying hardware of the pixels. For example, the display can be made up of multiple display layers for illustrating different information or providing different display functionality. The layers are implemented as software layers that are combined before being output to display. The alpha layer can be the display layer that transforms the underlying content for display to be partially or wholly transparent, which can uniformly attenuate the resulting brightness of the display and/or be used to selectively display certain pixels using, for example, an intermittence setting. When the layers are composited, the alpha layer can be a final or last layer in the stack of multiple display layers, and can indicate which pixel(s) to make more or less transparent and/or indicate which pixels to turn on or off.

In some embodiments, both the first approach 310 and the second approach 315 can include adding a 1-3-pixel wide blur step before turning pixels off. Especially in the second approach 315 (where two pixels of each four-pixel square unit are turned off in each cycle), some displayed content can appear “blocky” since pixels are turned off. In order to prevent this blocky appearance, the blur step can be applied to the original image being displayed (e.g., before applying a pixel off filter). The blur step can include a matrix operation running across the entire display without knowing which pixels are to be turned off. In this way, the blur effect will diffuse out the transition from pixels that are turned on to pixels that are turned off.

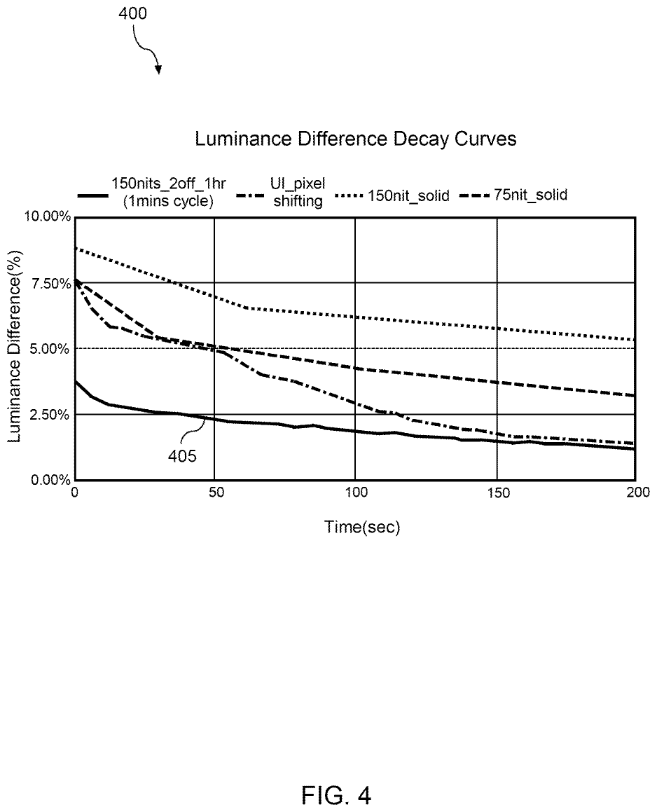

FIG. 4 illustrates a chart 400 showing a comparison of image retention contrast according to some implementations of the present disclosure. The image retention contrast is used to measure the visibility of an artifact when switching from stationary content to a normal user interface. First curve 405 illustrates that using the second approach 320 (in which two pixels of every four-pixel square unit are turned off every cycle) demonstrates a significant reduction of image retention contrast in comparison to other methods.

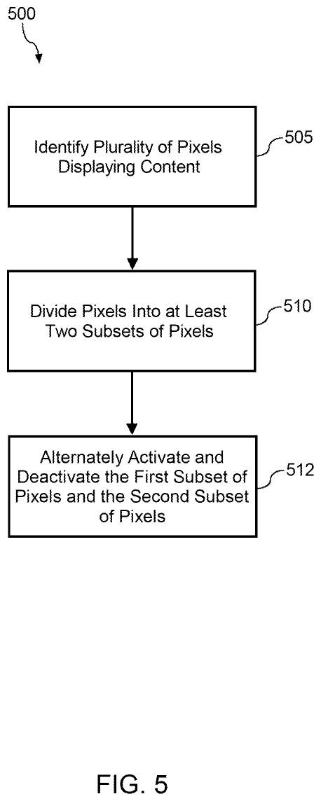

FIG. 5 illustrates a method 500 for displaying content on a display of a computing device according to some implementations of the present disclosure. In some embodiments, method 500 can be performed by one or more processors of the computing device and can be stored as instructions in a non-transitory, computer-readable medium that can be executed by the one or more processors of the computing device.

At block 505, the method 500 can include identifying a plurality of pixels that are displaying content on a display of the computing device. For example, if the display is currently configured to display content (e.g., date, time, battery information, weather information, etc.), method 500 can include identifying locations of displayed content and corresponding pixels associated with the locations. In some embodiments, pixel on/off switching operations, as described below, can be performed on all pixels displaying content on the display. In alternative embodiments, pixel on/off switching operations can be performed on only a subset of pixels displaying content.

At block 510, the method 500 can include dividing the identified pixels into at least two subsets of pixel groups. As described above with regards to FIG. 3, the pixels displaying content can be divided into four-pixel square units. However, in other embodiments, the pixels can be divided into groups or units of other sizes and/or shapes. Each of these four-pixel square units can then be subdivided into two or more pixel groups. In one implementation, each four-pixel square unit is divided into four pixel groups: one for each pixel in the four-pixel square unit. In a different implementation, each four-pixel square unit is divided into two pixel groups: one containing an upper-left pixel and lower-right pixel of the four-pixel square unit and one containing an upper-right pixel and lower-left pixel of the four-pixel square unit.

In either implementation, pixels from each four-pixel square unit are then grouped into larger pixel groups. For example, in the first implementation, each upper-left pixel of each four-pixel square unit can be grouped into a first plurality of pixels (“a pixel group”). In another example, in the second implementation, each identified pair of pixels (e.g., upper-left pixel and lower-right pixel) of each four-pixel square unit can be grouped into a first pixel group. In the first implementation, this grouping leads to four groups of pixels corresponding to the location of each pixel in a four-pixel square unit. In the second implementation, this group leads to two groups of pixels corresponding to the two sets of paired pixels in each four-pixel square unit.

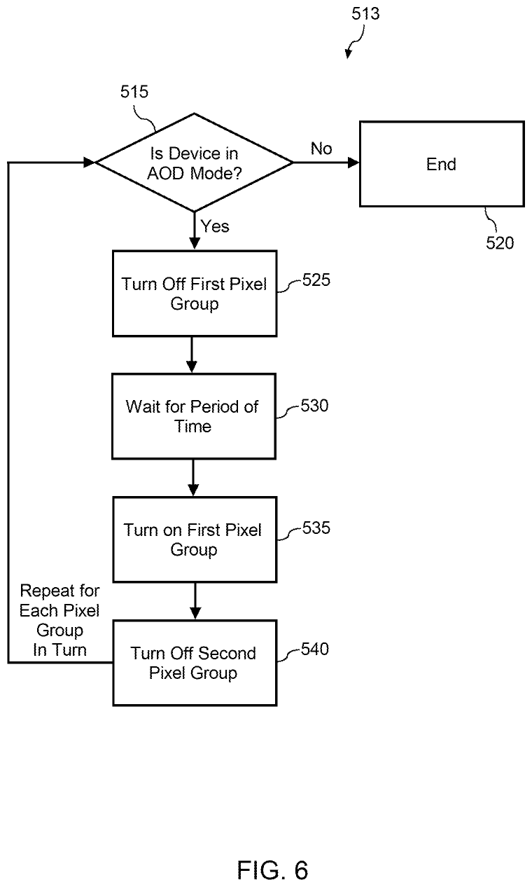

At block 512, the method 500 can include alternately activating and deactivating the identified subsets of pixels from block 510. For example, the method 500 can include turning off each pixel group in sequence while having all remaining pixel groups be on, “cycling” through each pixel group being off in turn. Additional details regarding the alternating activation and deactivation of pixel groups can be found below in relation to FIG. 6.

FIG. 6 illustrates a method 513 for alternately activating and deactivating subsets of pixels on a display of a computing device according to some implementations of the present disclosure. In some embodiments, method 513 can be performed by one or more processors of the computing device and can be stored as instructions in a non-transitory, computer-readable medium that can be executed by the one or more processors of the computing device.

At block 515, the method 513 can include determining whether the display of the computing device is operating in an AOD mode. This can be done by, for example, checking one or more settings in memory to determine if the display of the computing device is currently in the AOD mode.

If the computing device is not in an AOD mode (“no” at block 515), the method 513 can end (at block 520). In this case, the computing device can be in a normal display mode and therefore can turn off the display after a set period of time (user-defined or otherwise) or otherwise manage the display of content on the display of the computing device.

If the computing device is in an AOD mode (“yes” at block 515), the method 513 can include turning off a first pixel group of the plurality of pixel groups identified at block 510 (at block 525). For example, in the first implementation, the method 513 can include turning off all pixels in a first plurality of pixels that correspond to a lower-left pixel of each four-pixel square unit. In a different example, in the second implementation, the method 513 can include turning off all pixels in a first plurality of pixels that correspond to one matching pair of pixels (e.g., the upper-left pixel and the lower-right pixel) in each four-pixel square unit.

In some embodiments, the method 513 can implement an alpha display layer that includes information indicating individual pixels that will be turned off when the first pixel group is turned off. This alpha display layer can then be used to turn off the indicated pixels by identifying the locations of the pixels to be turned off to pixel power and activation logic of the computing device. This alpha display layer can then be re-generated for each new pixel group and/or as displayed content is updated.

At block 530, the method 513 can include waiting a period of time while the first pixel group is turned off. In some embodiments, this period of time can be one minute. This period of time allows the pixels that have been turned off to thoroughly “rest,” or not display content, which in turn allows for a longer pixel lifespan before displayed content can become “burnt in” on the pixels.

At block 535, the method 513 can include turning the pixels in the first pixel group back on. This can be performed by identifying which pixels should be turned back on from the alpha display layer and providing an indication of these pixels to pixel power and activation logic of the computing device.

At block 540, the method 513 can include turning off a second pixel group of the plurality of pixel groups identified at block 510. For example, in the first implementation, the method 513 can include turning off all pixels in a second pixel group that correspond to an upper-left pixel of each four-pixel square unit. In a different example, in the second implementation, the method 513 can include turning off all pixels in a second group of pixels that correspond to one matching pair of pixels (e.g., the upper-right pixel and the lower-left pixel) in each four-pixel square unit.

The method 513 can then be repeated in full or in part. For example, the method 513 can then repeat for each identified group of pixels, causing either one or two pixels of each four-pixel square unit to alternatively be turned off and on. This causes the desired displayed content to be displayed at a desired normal resolution or at a lower resolution than normal while still enabling pixels to be turned off and therefore relaxed in turn.

In some embodiments, the method 513 can include adding a 1-3-pixel wide blur step before turning pixels off. Especially in the second approach 315 (where two pixels of each four-pixel square unit are turned off in each cycle), some displayed content can appear “blocky” since pixels are turned off. In order to prevent this blocky appearance, the blur step can be applied to the pixels that are turned on.

In some embodiments, the method 513 can also include a pixel brightening step. When pixels are turned off, a resulting perceived brightness of the display can be affected. For example, a display calibrated at 3 nits would appear with a perceived brightness of 1.5 nits if two pixels are turned off for each four-pixel square unit. In some embodiments, it is desirable to have a reduction in brightness, such as when the computing device is operating at night or in other low-light conditions, or when the computing device is docked for charging.

In regular ambient light conditions, however, it may be desired to maintain a target display brightness set by the brightness of the environment. In order to compensate for the reduced perceived brightness, a display brightness value of pixels that are currently not turned off can be boosted. For example, given a desired brightness of 75 nits and using an implementation where one pixel is turned off per four-pixel square unit, the display brightness value of the three on pixels can be boosted to 100 nits while the fourth pixel is turned off. In an implementation where two pixels of each four-pixel square unit are turned off, each of the two pixels that are on can be boosted to 150 nits while the other two pixels are off.

In some embodiments, this change in display brightness can be affected dynamically based on an outside brightness detected by, for example, an ambient light sensor input. However, using this measurement alone can result in dimming the display below a desired value in a given environment. Therefore, a custom look-up table can be used for AOD mode. For example, when two pixels are turned off per cycle, the custom look-up table would need to specify a desired brightness value twice as large relative to a normal display mode (e.g., if a normal operating mode would require 50 nits of brightness, a computing device operating in AOD would require 100 nit brightness).

In some embodiments, it may be desired to increase the AOD brightness of on pixels above a hardware limit set for the computing device. For example, for a display programmed for a max AOD brightness of 150 nits, the perceived brightness would appear as 112.5 nits if one pixel of each four-pixel square was turned off. In another example, for a display programmed for a max AOD brightness of 150 nits, the perceived brightness would appear as 75 nits if two pixels of each four-pixel square was turned off. Therefore, especially in high ambient brightness scenarios (e.g., operation of the computing device while in sunlight), two different approaches can be used to compensate and achieve the desired brightness.

In one embodiment, a hardware approach can be used. In order to increase the brightness of the pixels using the hardware, the method 513 can include generating instructions to provide an increased current to pixels currently turned on. This increased current corresponds to the required increase in brightness needed based on how many pixels of each four-pixel square unit are turned off. For example, in order to achieve a 150-nit brightness value when two pixels of each four-pixel square unit is turned off, instructions can be generated to increase the current to on pixels as if the desired brightness for the on pixels was 300 nits.

In a second embodiment, a software approach can be used. For example, if the detected ambient lux condition is greater than 10,000, the method 513 can include operating with all pixels on for a period of time (e.g., 1-5 minutes) and, after the duration of this period of time, can enable a “dimming effect” by alternating turning off different groups of pixels as described above. In some embodiments, this “dimming effect” can be combined with existing pixel shifting methods to extend the duration of the AOD all pixels on state during the period of time, such that pixels are still relaxed even though the pixels are currently on.

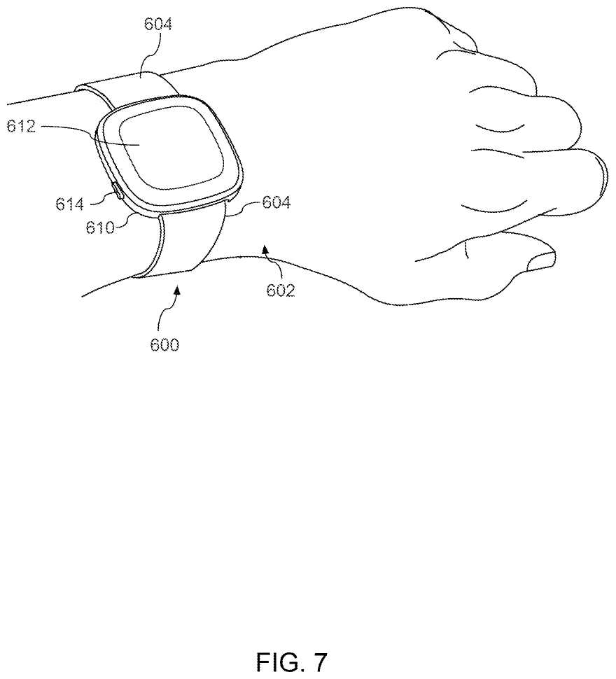

FIG. 7 depict a wearable computing device 600 according to some implementations of the present disclosure. As shown, the wearable computing device 700 can be worn, for instance, on an arm 602 (e.g., wrist) of a user. For instance, the wearable computing device 600 can include a band 604 and a housing 610. In some implementations, the housing 610 can include a conductive material (e.g., metal). In alternative implementations, the housing 110 can include a non-conductive material (e.g., a plastic material, a ceramic material).

The housing 610 can be coupled to the band 604. In this manner, the band 604 can be fastened to the arm 602 of the user to secure the housing 610 to the arm 602 of the user.

In some implementations, the wearable computing device 600 can include a display screen 612. The display screen 612 can display content (e.g., time, date, biometrics, etc.) for viewing by the user. In some implementations, the display screen 612 can include an interactive display screen (e.g., touchscreen or touch-free screen). In such implementations, the user can interact with the wearable computing device 600 via the display screen 612 to control operation of the wearable computing device 600.

In some implementations, the wearable computing device 600 can include one or more input devices 614 that can be manipulated (e.g., pressed) by the user to interact with the wearable computing device 600. For instance, the one or more input devices 614 can include a mechanical button that can be manipulated (e.g., pressed) to interact with the wearable computing device 600. In some implementations, the one or more input devices 614 can be manipulated to control operation of a backlight (not shown) associated with the display screen 612. It should be understood that the one or more input device 614 can be configured to allow the user to interact with the wearable computing device 600 in any suitable manner. For instance, in some implementations, the one or more input devices 614 can be manipulated by the user to navigate through content (e.g., one or more menu screens) displayed on the display screen 612.

While wearable computing device 600 is illustrated as an example computing device, it can be contemplated that details of the present disclosure can be implemented on other types of computing devices, such as smart cellular telephones, personal computers, tablet computers, personal digital assistants, laptop computers, and the like.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for refreshing pixels of a display operating in an always-on mode, the method comprising:
identifying a plurality of pixels of the display that are activated while the display is operating in the always-on mode;
dividing the plurality of pixels into at least two subsets of pixels including a first subset of pixels and a second subset of pixels, the first subset of pixels and the second subset of pixels being mutually exclusive; and
alternately activating and deactivating the first subset of pixels and the second subset of pixels.

2. The method of claim 1, wherein dividing the plurality of pixels into the at least two subsets of pixels includes:
dividing the plurality of pixels displaying content into four-pixel units; and
assigning each pixel of each four-pixel unit to one of the at least two subsets of pixels.

3. The method of claim 2, wherein each four-pixel unit is a two-by-two unit of pixels displaying content.

4. The method of claim 3, wherein the at least two subsets of pixels includes two subsets of pixels, wherein assigning each pixel of each four-pixel unit to at least one of the two subsets of pixels includes:
identifying two identified pixels of the four-pixel unit as being pixels diagonally separated from one other in the two-by-two unit of pixels;
assigning the two identified pixels to the one of the two subsets of pixels; and
assigning the other two pixels of the four-pixel unit to a second of the two subsets of pixels.

5. The method of claim 3, wherein the at least two subsets of pixels includes four subsets of pixels and wherein assigning each pixel of each four-pixel unit to one of the four subsets of pixels includes assigning each pixel in the four-pixel unit to a different subset of pixels of the four subsets of pixels.

6. The method of claim 5 wherein alternately activating and deactivating the first subset of pixels and the second subset of pixels includes:
turning on a second of the four subsets of pixels;
turning off a third of the four subsets of pixels;
waiting a period of time;
turning on the third of the four subsets of pixels; and
turning off a fourth of the four subsets of pixels.

7. The method of claim 1, wherein alternately activating and deactivating the first subset of pixels and the second subset of pixels includes:
turning off at least one of the at least two subsets of pixels;
waiting a period of time;
turning on the at least one of the at least two subsets of pixels; and
turning off a second of the at least two subsets of pixels.

8. The method of claim 1, further comprising increasing a brightness of a subset of pixels of the at least two subset of pixels currently being displayed by increasing a current provided to pixels in the subset of pixels.

9. The method of claim 1, wherein alternately activating and deactivating the first subset of pixels and the second subset of pixels includes:
identifying which pixels of the display must be turned off based on the subset of pixels of the at least two subsets of pixels;
providing the identified pixels to an alpha display layer; and
using the alpha display layer to turn off the identified pixels.

10. The method of claim 1, further comprising performing an image blurring step before turning off a subset of pixels of the at least two subsets of pixels.

11. A computing device, the computing device comprising:
a display;
one or more processors; and
a memory comprising instructions that, when executed by the one or more processors, cause the one or more processors to perform operations, the operations comprising:
identifying a plurality of pixels of the display that are activated while the display is operating in an always-on mode;
dividing the plurality of pixels into at least two subsets of pixels including a first subset of pixels and a second subset of pixels, the first subset of pixels and the second subset of pixels being mutually exclusive; and
alternately activating and deactivating the first subset of pixels and the second subset of pixels.

12. The computing device of claim 11, wherein dividing the plurality of pixels into the at least two subsets of pixels includes:
dividing the plurality of pixels displaying content into four-pixel units; and
assigning each pixel of each four-pixel unit to one of the at least two subsets of pixels.

13. The computing device of claim 12, wherein each four-pixel unit is a two-by-two unit of pixels displaying content.

14. The computing device of claim 13, wherein the at least two subsets of pixels includes two subsets of pixels, wherein assigning each pixel of each four-pixel unit to at least one of the two subsets of pixels includes:
identifying two identified pixels of the four-pixel unit as being pixels diagonally separated from one other in the two-by-two unit of pixels;
assigning the two identified pixels to the one of the two subsets of pixels; and
assigning the other two pixels of the four-pixel unit to a second of the two subsets of pixels.

15. The computing device of claim 13, wherein the at least two subsets of pixels includes four subsets of pixels and wherein assigning each pixel of each four-pixel unit to one of the four subsets of pixels includes assigning each pixel in the four-pixel unit to a different subset of pixels of the four subsets of pixels.

16. The computing device of claim 15 wherein alternately activating and deactivating the first subset of pixels and the second subset of pixels includes:
turning on a second of the four subsets of pixels;
turning off a third of the four subsets of pixels;
waiting a period of time;
turning on the third of the four subsets of pixels; and
turning off a fourth of the four subsets of pixels.

17. The computing device of claim 11, wherein alternately activating and deactivating the first subset of pixels and the second subset of pixels includes:
turning off at least one of the at least two subsets of pixels;
waiting a period of time;
turning on the at least one of the at least two subsets of pixels; and
turning off a second of the at least two subsets of pixels.

18. The computing device of claim 11, the operations further comprising increasing a brightness of a subset of pixels of the at least two subset of pixels currently being displayed by increasing a current provided to pixels in the subset of pixels.

19. The computing device of claim 11, wherein alternately activating and deactivating the first subset of pixels and the second subset of pixels includes:
identifying which pixels of the display must be turned off based on the subset of pixels of the at least two subsets of pixels;
providing the identified pixels to an alpha display layer; and
using the alpha display layer to turn off the identified pixels.

20. The computing device of claim 11, the operations further comprising performing an image blurring step before turning off a subset of pixels of the at least two subsets of pixels.
